(19) United States
(12) Patent Application Publication
(10) Pub. No.: US 2016/0330232 A1
(43) Pub. Date: Nov. 10, 2016

(54) MALICIOUS AUTHORIZED ACCESS PREVENTION APPARATUS AND METHOD OF USE THEREOF

(71) Applicant: Rajesh Kumar, Phoenix, AZ (US)

(72) Inventor: Rajesh Kumar, Phoenix, AZ (US)

(21) Appl. No.: 14/706,913

(22) Filed: May 7, 2015

(51) Int. Cl. H04L 29/06

(52) U.S. Cl. CPC H04L 63/1441; H04L 63/20; H04L 63/08

(57) ABSTRACT

The invention comprises a predictive security system apparatus and method of use thereof for predicting a threat level of illicit activity of an actor, the actor using authorized access to company information in generation of a threat. The predictive security system optionally: collects data; processes the data with a predictive engine to predict a threat; checks predicted threats against policies via a policy engine; determines a threat level using a threat engine; checks the threat level against a threshold or metric; and/or reports the threat leading to one or more actions. Optionally, the predictive security system is adaptive and/or iterative based on new information.

### BACKGROUND OF THE INVENTION

1. Field of the Invention

The invention relates to prevention of malicious activity by authorized users using authorized access.

2. Discussion of the Prior Art

### Authorized Access

Modern business must grant levels of access to a business' systems as a coarse of business. Unfortunately, some individual's and/or groups have used this access for their own gains and/or to hurt the business.

### Problem

What is needed is a system for addressing illicit uses of authorized access.

### SUMMARY OF THE INVENTION

The invention comprises a malicious authorized access prevention apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a predictive modeling overview for prevention/mitigation of illicit activity using permitted access;

FIG. 2 illustrates a data collection system;

FIG. 3 illustrates a prediction engine;

FIG. 4 illustrates a policy engine;

FIG. 5 illustrates a threat assessment/rules engine; and

FIG. 6 illustrates a reporting system.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises an apparatus and method of use thereof for predicting a threat level of an action from an actor, the actor using authorized access to company information in generation of a threat.

In one embodiment, a predictive security system is provided. The predictive security system optionally: collects data; processes the data with a predictive engine to predict a threat; checks predicted threats against policies via a policy engine; determines a threat level using a threat engine; checks the threat level against a threshold or metric; and/or reports the threat leading to one or more actions. Optionally, the predictive security system is adaptive and/or iterative based on new information. The predictive security system and components thereof are further described, infra.

### Detection of Illicit Activity of Actor Using Authorized Access to Company Property

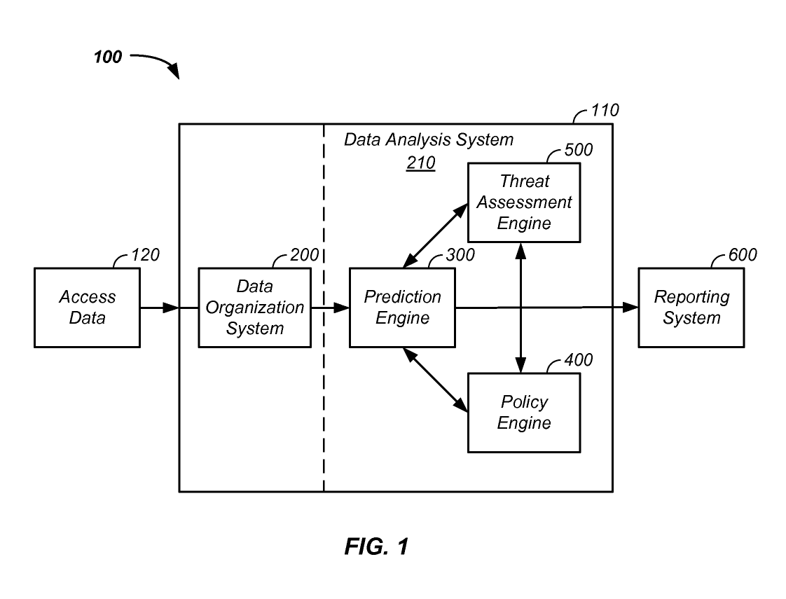

Referring now to FIG. 1, a preventative damage system 100 is illustrated. The preventative damage system predicts illicit activity, detects illicit activity, and/or is used in prevention of illicit activity of an actor, where the actor uses authorized access to company property to achieve the illicit activity. Herein, the term actor is used to refer to an individual, an employee, a group, a contractor, a vendor, and/or a thief. Herein, company property refers to goods, services, information about the company, information gathered by the company, and/or information held by the company.

Still referring to FIG. 1, an overview of the preventative damage system 100 is herein provided. The preventative damage system 100 uses a threat assessment system 110 to: gather access data 120 and derivatives thereof, process the access data 120 and the derivatives into status/threat information, and to output the detected and/or calculated status/threat information to a reporting system 600. The access data 120 includes structured and/or unstructured data related to access by the actor. The access data 120 is processed/organized using a data organization system 200 and data analysis system 210 of the threat assessment system 110, such as into an access database where the access database contains data access information of the actor. Structured output from the data organization system 200 is sent to a prediction engine 300. The prediction engine 300 generates one or more calibrations and predictions using the structured output to generate potential threat information. The potential threat information is further analyzed using one or both of: (1) a policy engine 400 testing the potential threat information against company policy and (2) a threat assessment engine 500, also referred to herein as a rules engine, used to establish a threat identification and associated threat level of the potential threat information. The threat identification is sent, such as via a controller 320, to the reporting system 600, where appropriate action is initiated. The optional subsystems of the preventative damage system 100 are further described, infra.

### Data Collection System

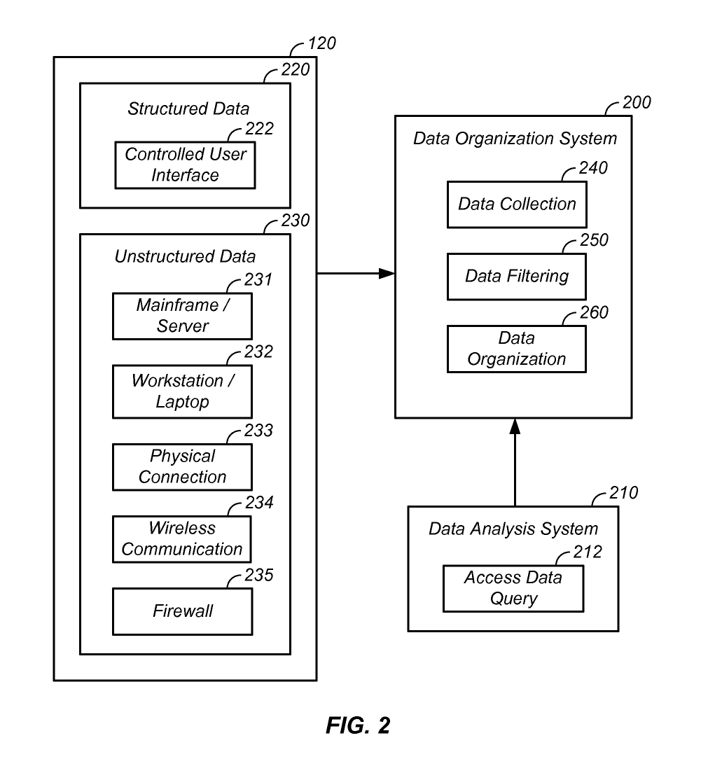

Referring now to FIG. 2, the data organization system 200 is further described. The data organization system 200 gathers, filters, and/or organizes the access data 120 and surrounding data related to the access data 120 to yield organized data. Generally, the access data 120 is structured data 220 and/or unstructured data 230. For example, structured data 220 is information arising through a controlled user interface 222 where particular information is identified with fillable fields. More often, unstructured data 230 is provided to the data organization system 200, such as via a mainframe and/or server 231, a workstation and/or a laptop 232, via a physical connection 233, through wireless communication 234, and/or through a firewall 235. The unstructured data 230 is broad in nature and includes not only access information of the actor, such as time and place of access, but also when access happened, where access happened, how access happened, what accessed information was obtained, and what is related to the accessed information. The data organization system 200 sorts and/or organizes the data from multiple sources into one or more databases contained on one or more physical systems, such as a computer, server, hard drive, physical storage medium, or the like. Organized data from the data organization system 200 is passed to the prediction engine 300, once, periodically, as needed, as requested, and/or continually.

### Prediction Engine

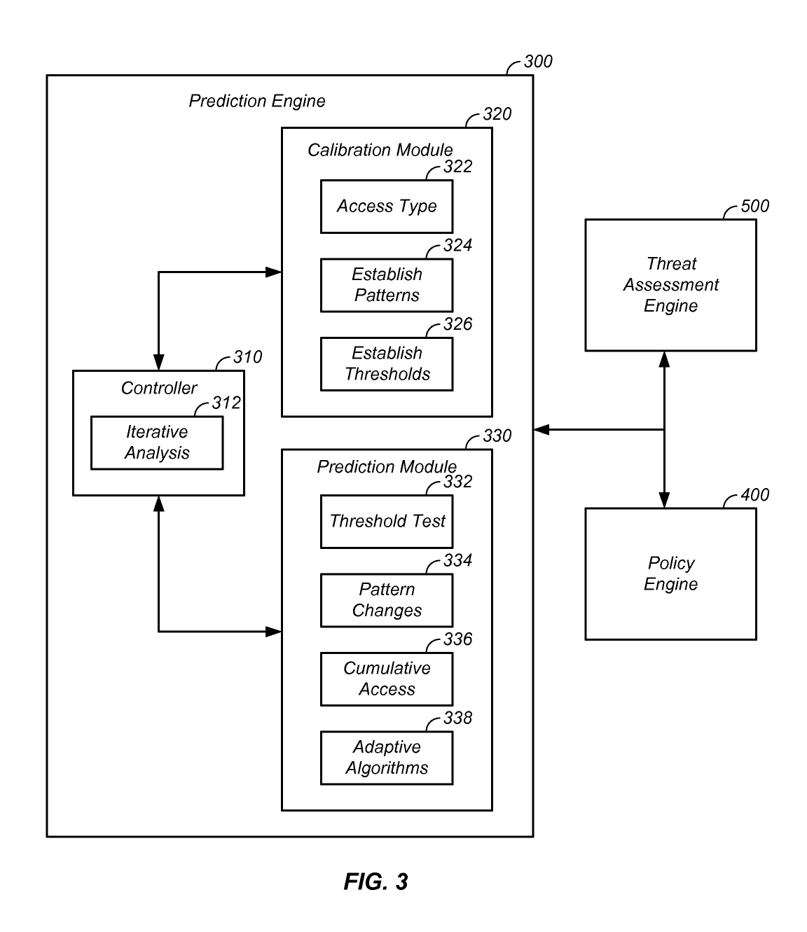

Referring again to FIG. 1 and now to FIGS. 3-5, the prediction engine 300, the policy engine 400, and the threat assessment engine 500 optionally function independently and optionally individually deliver one or more identified threats to the reporting system 600. However, preferably the prediction engine 300, the policy engine 400, and the threat assessment engine 500 cooperate to assess risk of action of the actor. Preferably, the cooperative analysis is performed iteratively, as described infra.

Referring again to FIG. 3, the prediction engine 300 is further described. The prediction engine 300 uses a controller 310 to control a calibration module 320 and a prediction module 330. Generally, the calibration module 320 forms one or more calibration models using the organized data from the data organization system 200. Subsequently, the prediction module 330, operating on the original organized data and/or updated organized data, generates a prediction, such as the potential threat information. The calibration module 320 and prediction module 330 optionally operate without use of the controller 310.

Still referring to FIG. 3, the calibration module 320 and prediction module 330 are further described. Generally, the calibration module 320 forms a calibration model and the prediction model applies the calibration model to data to determine a compliance, a uniformity, a consistency, an outlier, and/or a prediction. Several specific examples are provided herein, without loss of generality, to clarify the invention.

### Example I

In a first example, a narrow exemplary model is provided to clarify the invention. In the first example, the calibration module 320 forms a model of access type 322 as a function of a variable, such as an actor identification, time, and/or location typically in association with accessed information, such as company property information. Subsequently, the prediction module 330 applies the calibration model to previous data, real-time data, and/or unanalyzed data to determine if the data is within the norm of the model or is an outlier, either of which is useful dependent upon the model type. In one case, the predicted data shows an outlier where an actor is accessing or has accessed data at an odd time, an odd place, and/or of a non-typical type. In another case, the predicted data shows an unusual volume of information obtained and/or accessed sensitive information. In a third case, the predicted data shows uniformity with the model; which is good for a model seeking acceptable performance or identifies a problem for a model designed to show illicit action.

### Example II

In a second example, a wider exemplary model is provided to still further clarify the invention. In the second example, the calibration module 320 builds a model using the organized data and/or pre-processed data, described infra, where the model establishes one or more patterns 324 and/or establishes one or more thresholds 326 for acceptable, questionable, and/or unacceptable behavior of the actor. Subsequently, the prediction module 330 tests the original organized data, updated organized data, and/or preprocessed data in terms of a threshold test 332, pattern change 334, and/or cumulative access 336, where the cumulative access 336 is concatenated, summed, or partially summed data acquired by a user over a time period. The prediction module 330 yields anomalies that are identified as potential threat information.

### Preprocessing

The data organization system 200 and/or the data analysis system 210 optionally preprocesses the original organized data and/or updated organized data. Preprocessing or feature extraction is any mathematical transformation that enhances a quality or aspect of the sample measurement for interpretation. The general purpose of preprocessing is to aid in concise representation of the potential illicit activity in view of the substantial background noise all permitted activities. Preprocessing optionally includes one or more of: outlier analysis, standardization, filtering, correction, and application to a linear or nonlinear model for generation of an estimate (measurement) of the targeted element.

Preprocessing also optionally includes an analysis of vectors and/or matrices of data using one or more of: a background removal, a normalization, a smoothing algorithm, taking a mathematical derivative, use of multiplicative signal correction, use of a standard normal variate transformation, use of a piecewise multiplicative scatter correction, use of an extended multiplicative signal correction, and/or use of a multivariate model, such as principal components regression or partial least squares regression. Pre-processing routines are used to enhance signal, reduce noise, reduce outliers, and/or to simplify or clarify the data. Notably, the preprocessing techniques are used to build more accurate models and to predict more accurately on data for the use of prevention of illicit activity of an actor, where the actor has used authorized access to company property in past, on-going, and/or predicted future illicit activity.

### Example III

For conciseness and clarity of presentation, modification of a background removal algorithm to apply to prediction of illicit activity by an actor is presented as representative of application of the above identified algorithm types to preprocessing the organized data from the data organization system 200. Particularly, a step of background removal is optionally used to enhance identification of small pattern changes relative to background activity.

Backgrounds are optionally individually determined for each actor. For instance, a particular actor has a history of data access and removal of the predicted background access amplifies small differences to help identify illicit activity. Obviously, direct subtraction is just one form of background removal. For instance, the background removal step optionally calculates a difference between the estimated actor pattern the observed pattern, x, through equation 1,

z=x−(cx₁+d) (eq.1)

where x₁ is the estimated actor access pattern based upon prior assignments tasks given to the actor and c and d are slope and intercept adjustments to the access pattern. The variables c and d are preferably determined on the basis of features related to the dynamic variation of the access pattern based upon current assignments given to the actor relative to past assignments. The process of applying background removal to the processed data is representative of application of any of the other preprocessing techniques, described supra, to the organized data set to aid in uncovering illicit activity.

### Intelligent System

Still referring to FIG. 3, an optional intelligent system for determining illicit activity of an actor is provided, where the illicit activity of the actor improperly uses the actor's legitimate company granted access to company information. In this example, which again is an example of application of an algorithm type to the problem identified herein, a pattern classification engine is used to model access patterns of the actor. Preferably, a priori information about the actor's legitimate company data access is used in the calibration module 320. Again, differences between the actor's previous legitimate access and the possible current illicit activity is extracted using a priori information about the actor's current assignments.

### Modeling

Subsequent data analysis, such as with the calibration module 320, optionally includes use of a soft model, a multivariate calibration, a genetic algorithm, and/or a neural network. The calibration model is optionally applied to a group of actors, as opposed to the entire data set, to enhance a signal-to-noise ratio related to the illicit activity. Subsequent application of the prediction module 330 is applied to the narrowed sample type.

### Algorithms

Algorithms used by the calibration module 320, in the process of establishing patterns 324, and/or in the process of establishing thresholds 326, optionally after the preprocessing described supra, include, but are not limited to:
a classification algorithm;
a supervised algorithm;
a decision tree;
a decision list;
a Bayesian classifier;
a neural network;
a genetic algorithm;
a clustering algorithm;
a multivariate model;
a Kalman filter;
a particle filter;
an expert system;
a hierarchical system; and/or
a hierarchical mixture of experts.

Generally, any of the preprocessing, intelligent system, modeling, and/or algorithms described herein are optionally used by the policy engine 400 and/or the threat assessment engine 500.

### Policy Engine

Still referring to FIG. 3, the prediction engine 300 optionally and preferably passes the potential threat information to the policy engine 400 and/or to the threat assessment engine 500 for further threat analysis, to enhance a probability of illicit action or to enhance a probability of non-illicit action. While the policy engine 400 is described before the threat assessment engine 500, optionally the threat assessment engine first processes the potential threat information before analysis with the policy engine 400.

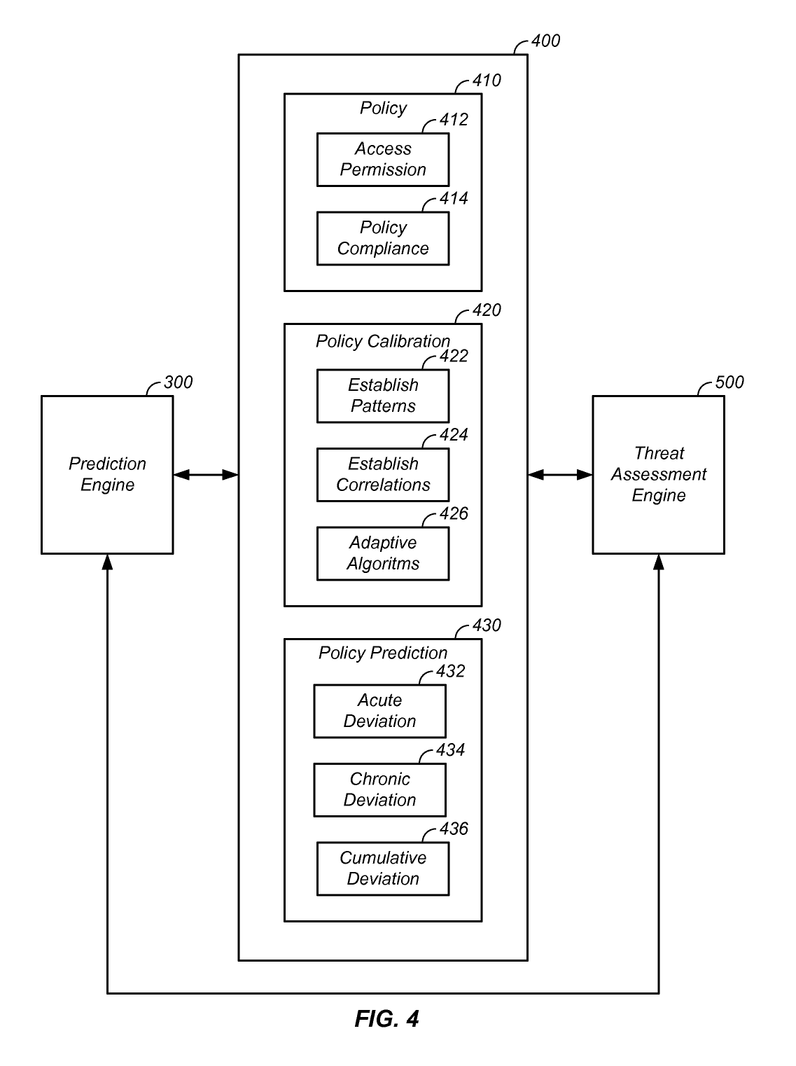

Referring now to FIG. 4, the policy engine 400 is further described. As described, supra, the prediction engine 300 generates potential threat information. However, the prediction engine 300 optionally casts a broad net and therefore the established potential threat information is possibly legitimate/authorized use of the company's information. Thus, the potential threat information is optionally and preferably further analyzed using the policy engine 400.

Still referring to FIG. 4, the policy engine 400 further evaluates the potential threat information from the prediction engine 300 and/or from the threat assessment engine 500. For instance, the policy engine 400 checks the established potential threat information against company policy 410. Two non-limiting examples, used to further clarify the invention, are the policy engine 400: testing the potential threat information against access permission 412 and/or testing against policy compliance 414 for the identified actor. In a first example, a company employee may have been tasked with generating a report of business performance of each division of a company for the last four quarters. Hence, a flag raised in the form of the established potential threat for the actor accessing: sensitive information, information from multiple divisions, and/or an unusual volume of information is likely legitimate. In a second example, a contractor may have had access to a company sub-system for development of a quote for solving a problem. The policy engine 400 tests the established potential threat information against a fact, such as the quote was delivered after one week of analysis two weeks ago, yet data is still being accessed by the contractor, which adds to the likelihood that the continued data access is improper. After analysis, the policy engine 400 concatenates the finding to the potential threat information report or otherwise modifies the potential threat information report and sends the now filtered report back to the prediction engine 300 for further analysis, to the threat assessment engine 500 for further analysis, and/or to the reporting system 600.

Still referring to FIG. 4, the policy engine 400 is still further described. Optionally, the policy engine 400 further processes the potential threat information using a policy calibration and prediction routine 420, 430. The policy calibration and prediction routine 420, 430 is optionally used with or without use of the calibration and prediction module 320, 330 of the prediction engine 300. The policy engine 400 optionally uses the policy calibration routine 420 to establish patterns 422, establish correlations 424, and/or use adaptive algorithms 426 and subsequently uses policy prediction routines, such as examination of the potential threat information of the actor against an acute deviation test 432, a chronic deviation test 434, and/or a cumulative deviation test 436.

Still referring to FIG. 4, optionally, the policy engine generates its own potential threat information using data from the data organization system 200 using one or more of: examination against company policy 410, the policy calibration routine 420, and the policy prediction routine 430.

### Threat Assessment Engine

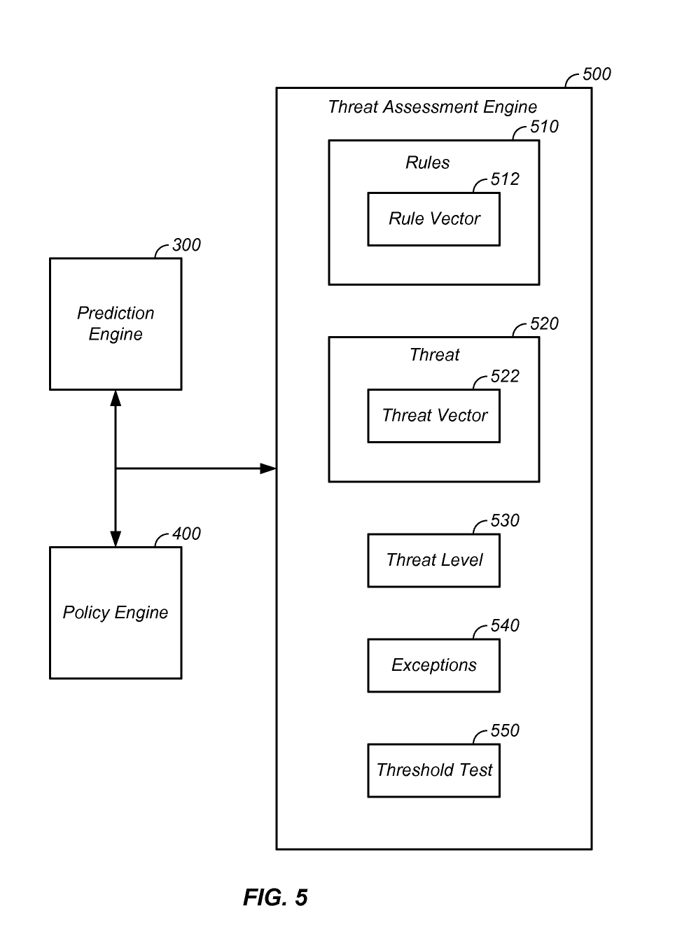

Referring again to FIG. 5, the threat assessment engine 500 optionally and preferably receives the potential threat information from the prediction engine 300 and/or from the policy engine 400 for further threat analysis, to further enhance the probability of illicit action or to enhance the probability of non-illicit action.

Still referring to FIG. 5, the threat assessment engine 500 optionally analyzes the potential threat information against rules 510, such as using a rule vector 512, and analyzes the threat 520, such as by use of a threat vector 522. The rule vector 512 assigns a rule weight to the potential threat information and the threat vector 522 assigns a threat adjustment weight to the rule, such as through equation 2:

threat level=threat weight*rule weight (eq.2)

where the threat level combines the rule being infringed with a risk as assigned by the threat weight. For example, an employing logging in late breaks a rule that carries very little weight yielding a low threat level. However, an actor accessing personal medical information of employees breaks a rule with a large weight yielding a high threat level. Generally, the threat level is a mathematical representation of a combination of information from the prediction engine 300, policy engine 400, and/or the threat assessment engine rule 412 and threat 520 system. The threat level 530 is optionally further assessed 510 in view of known exceptions 540, such as backing up company data, a specific report, trust assigned to the actor, historical threats of the actor being verified as legitimate, and the like. The threat level 530 is preferably applied against a threshold test 550. Upon failing the threshold test 550 the now established threat risk is reported to the reporting system 600 and/or is automatically further analyzed, as described infra.

### Automated Iterative/Updated Analysis

Referring again to FIGS. 2 and 3, optionally the data analysis engine 210, prediction engine 300, policy engine 400, and/or threat assessment engine 500, upon determination of a threat, automatically directs the data organization system 200 to acquire more information related to the identified threat via an access data query 212. The access data query 212 is optionally repeated as many times as necessary to bring the identified threat to a level sufficiently below the threshold test 550 to rule out the threat or to bring the threat level 530 above the threshold test 550 for reporting to the reporting system 600.

In another embodiment of the invention, a condition is set to provide continuous or nearly continuous analysis of potential illicit activity by repeating on a near continual basis use of the data organization system 200 and/or data analysis system 210. For example, mathematical tools or filters are used to enhance and/or iteratively enhance prediction of illicit activity and/or confidence of an identified threat of an actor. Examples of tools or filters for processing a data stream include: moving averages, slopes, outlier removal techniques, expected value comparison, smoothing, finite impulse response filters, infinite impulse response filters, and derivatives. The continuous automated analysis allows almost real-time assessment of potential threats.

### Reporting System

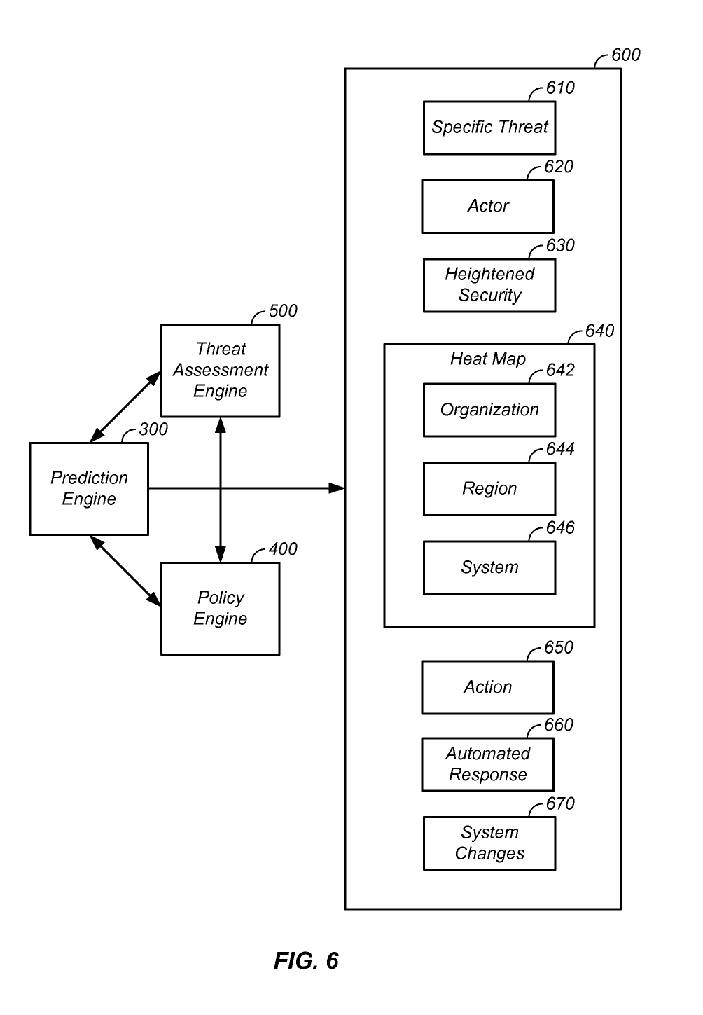

Referring now to FIG. 6, the reporting system 600 is optionally and preferably an interface of the computer implemented analysis of the threat assessment system 110 to a human user. The threat assessment system is implemented on one or more computers using physical interface connections, such as a wireless receiver or physical connection, to the access data 120. The data organization system 200 is implemented and stored using one or more computer processors and a form or storage medium, such as a hard drive. The interface is optionally any physical element configured for observing by or interaction by a threat analyst. Examples of physical elements include a computer monitor and a control panel implemented to view at least output of the threat assessment system.

Still referring to FIG. 6, the optional elements of the reporting system 600 are further described. Preferably, the reporting system 600 reports at least one of: a specific threat 610, a specific actor 620 associated with the specific threat 610, an area for heightened security 630, a heat map 640, a suggested action 650, a report of an automated response 660, and/or a recommended system change 670. Examples of a heat map 640 include reports related to a specific organization 642, region 644, or system 646. Generally, the reporting system 600 is an interface to the analyst and/or a tool for use of the analyst.

### Computer

The threat assessment system optionally and preferably uses a system controller, which optionally comprises one or more subsystems stored on a client. The client is a computing platform configured to act as a client device or other computing device, such as a computer, personal computer, a digital media device, and/or a personal digital assistant. The client comprises a processor that is optionally coupled to one or more internal or external input device, such as a mouse, a keyboard, a display device, a voice recognition system, a motion recognition system, or the like. The processor is also communicatively coupled to an output device, such as a display screen or data link to display or send data and/or processed information, respectively. In one embodiment, the system controller is the processor. In another embodiment, the system controller is a set of instructions stored in memory that is carried out by the processor. In still another embodiment, the remote system is the processor.

The client includes a computer-readable storage medium, such as memory. The memory includes, but is not limited to, an electronic, optical, magnetic, or another storage or transmission data storage medium capable of coupling to a processor, such as a processor in communication with a touch-sensitive input device linked to computer-readable instructions. Other examples of suitable media include, for example, a flash drive, a CD-ROM, read only memory (ROM), random access memory (RAM), an application-specific integrated circuit (ASIC), a DVD, magnetic disk, an optical disk, and/or a memory chip. The processor executes a set of computer-executable program code instructions stored in the memory. The instructions may comprise code from any computer-programming language, including, for example, C originally of Bell Laboratories, C++, C#, Visual Basic® (Microsoft, Redmond, Wash.), Matlab® (MathWorks, Natick, Mass.), Java® (Oracle Corporation, Redwood City, Calif.), and JavaScript® (Oracle Corporation, Redwood City, Calif.).

Still yet another embodiment includes any combination and/or permutation of any of the elements described herein.

Herein, a set of fixed numbers, such as 1, 2, 3, 4, 5, 10, or 20 optionally means at least any number in the set of fixed number and/or less than any number in the set of fixed numbers.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for prevention of malicious use of authorized access of an electronic database of company information by an authorized actor of a company, comprising the steps of:
using a computer implemented threat assessment system, said threat assessment system comprising the steps of:
collecting data related to authorized access of the company information gathered by the authorized actor into an access database with a data collection engine;
using a prediction engine to analyzer the access database, said prediction engine:
calibrating at least one access pattern of the authorized actor, and
generating a potential threat using differences between access information of the actor and the at least one access pattern;
testing the potential threat against company policy using a policy engine;
generating a mathematical threat level of the potential threat with a threat assessment engine; and
said threat assessment system combining output of said prediction engine, said policy engine, and said threat assessment engine to generate a specific threat; and
reporting said specific threat with a reporting system.

2. The method of claim 1, wherein the authorized actor comprises any of: an employee, a contractor, and a vendor.

3. The method of claim 2, wherein said policy engine and said threat assessment engine cooperate to assess the potential threat.

4. The method of claim 3, wherein said policy engine and said threat assessment engine iteratively cooperate to assess the potential threat.

5. The method of claim 2, further comprising the step of:
the actor using a company provided password to access the electronic database of company information.

6. The method of claim 5, said step of collecting data further comprising the steps of at least two of:
gathering access identity of the actor accessing the database of company information;
gathering access times of the actor accessing the database of company information;
gathering at least one access location of the actor when accessing the database of company information; and
gathering information accessed by the actor from the database of company information.

7. The method of claim 6, said step of collecting further comprising the step of:
organizing information gathered in said step of collecting into a searchable format.

8. The method of claim 7, said step of collecting further comprising the step of:
determining information related to the information accessed by the actor, wherein the information related to the information accessed by the actor is not directly accessed by the actor.

9. The method of claim 6, said step of collecting, after said step of calibrating and after said step of predicting, further comprising the steps of:
periodically updating the information accessed by the actor;
continuously updating the information accessed by the actor; and
updating the information accessed by the actor according to a schedule.

10. The method of claim 6, said step of calibrating further comprising the step of:
forming at least one calibration model relating previously accessed information of the database of the company information by said actor to at least one of: (1) the access times of the actor; (2) the access location of the actor; and (3) currently accessed information of the actor from the database of company information.

11. The method of claim 10, said step of predicting further comprising:
determining an outlier in an access pattern, by the actor, of at least one of: (1) the previously accessed information and (2) the currently accessed information.

12. The method of claim 10, said step of predicting further comprising at least one of the steps of:
determining a non-typical access time, using the calibration model, of the actor accessing the database of company information; and
determining an outlier access location, using the calibration model, of where the actor accesses the database of company information.

13. The method of claim 10, said step of predicting comprising at least one of the steps of:
determining at least a three hundred percent increase in an amount of data accessed, using the calibration model, from the database of company information by the actor in at least one of: (1) one access session and (2) cumulatively from multiple access sessions of the actor.

14. The method of claim 4, said step of testing the potential threat against company policy using the policy engine further comprising the step of:
identifying access of the database of company information by the subcontractor after completion of an associated subcontract.

15. The method of claim 4, said step of testing the potential threat against company policy using the policy engine further comprising the step of:
identifying access of the database of company information by the actor from a non-approved location.

16. The method of claim 4, said step of generating a mathematical threat level of the potential threat with the threat assessment engine further comprising the step of:
mathematically combining a preassigned threat type weight with a previously assigned rule weight in determination of the mathematical threat level.

17. The method of claim 4, said threat assessment system further comprising the step of:
prognosticating a future threat from the actor.

18. The method of claim 4, said threat assessment system further comprising the step of:
prognosticating a future threat from a set of the actors, using combined access patterns of the database of company information by the set of actors, wherein the set of actors comprises at least three actors.

19. An apparatus for prevention of malicious use of authorized access of an electronic database of company information by an authorized actor of a company, comprising:
a computer implemented threat assessment system, comprising:
a data collection engine configured to collect and organize data related to authorized access of the company information gathered by the authorized actor into an access database;
a prediction engine, said prediction engine configured to:
calibrate at least one access pattern of the authorized actor, and
generate a potential threat using differences between access information of the actor and the at least one access pattern;
a policy engine configured to test the potential threat against company policy; and
a threat assessment engine configured to generate a threat level of the potential threat,
wherein said threat assessment system combines output of said prediction engine, said policy engine, and said threat assessment engine to generate a specific threat; and
a reporting system configured to report said specific threat.

20. The apparatus of claim 19, further comprising:
said reporting system configured to provide essentially real-time assessment of potential threats.
